(19) United States
(12) Patent Application Publication
(10) Pub. No.: US 2009/0127800 A1
(43) Pub. Date: May 21, 2009

(54) Crankcase seal for air-cooled engines

(76) Inventors: Kennith Lloyd Tunnell, Visalia, CA (US); Lloyd Junior Tunnell, Visalia, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/985,772

(22) Filed: Nov. 16, 2007

(51) Int. Cl. F02F 11/00

(52) U.S. Cl. 277/591

(57) ABSTRACT

An improved crankcase seal for air-cooled engines, such as the type utilized in aircraft and automobiles, comprises a groove cut into the planar mating surface of one of the crankcase component halves and a generally compressible sealing member disposed in the groove such that when the two crankcase halves are joined together the sealing member is disposed therebetween to seal the mating surface interface. Preferably, the groove is machine cut into the mating surface with a CNC machine and is provided with a pair of opposing upper edges that are spaced apart a distance less than the width of the sealing member such that the sealing member is securely held in the groove during assembly of the crankcase. In one configuration, the groove has a dovetail profile and the sealing member has a circular cross-section. The crankcase seal is particularly beneficial for horizontally opposed aircraft engines and the like.

### BACKGROUND OF THE INVENTION

A. Field of the Invention

The field of the present invention relates generally to sealing devices and systems for sealing the mating surfaces of two adjoining components. More particularly, the present invention relates to such sealing devices and systems that are beneficially utilized for sealing the mating surface interface of two adjoining crankcase components of an air-cooled engine. Even more particularly, the present invention relates to an improved crankcase seal that is useful for sealing the adjoining crankcase components of horizontally opposed air-cooled aircraft engines and the like.

B. Background

Air-cooled engines, such as many aircraft engines, are typically comprised of a pair of crankcase components that are assembled together to form the engine crankcase. With regard to horizontally opposed aircraft engines, the pair of matching crankcase components, commonly referred to as “left hand” and “right hand” crankcase halves, are configured such that the mating surfaces of the two crankcase components, when assembled, are in the same vertical plane that passes through the center line of the engine crankshaft and camshaft. For this type of engine design, hot engine oil continually circulates inside the crankcase when the engine is in operation. The mating surfaces of the two crankcase components are sealed such that the engine is expected to remain substantially leak free between engine overhauls. As well known in the art, the temperature and pressure conditions under which such engines operate can wear down a seal and result in a leak. If an oil leak develops anywhere along the crankcase mating surface interface, the only effective method of stopping the leak is to reseal the entire engine crankcase. Resealing the crankcase requires removal of the engine from the aircraft, complete disassembly of the engine, thorough cleaning of the crankcase halves, application of a new crankcase seal, re-assembly of the engine, re-installing the engine in the aircraft and test running of the engine to verify that there are no oil leaks. As readily familiar to most aircraft owners and/or operators, resealing the crankcase to resolve an oil leak problem is expensive and results in loss of use of the aircraft for the period of time necessary to effectuate the repair.

The design of the crankcase for horizontally opposed aircraft engines, as well as other air-cooled engines, requires that the mating surfaces of the two crankcase halves be in direct contact with each other so as to maintain crankshaft and camshaft bearing clearances and to achieve specific crankcase bolt torque levels. As a result, conventional sealing devices and methods, such as those which utilize compressible gaskets made of paper, cork or rubber, are not suitable for use to seal these crankcases. Originally, metal-to-metal sealing of the two crankcase halves where utilized to obtain the desired seal. Presently, the accepted method of sealing these aircraft engine crankcase halves is to utilize silk thread and a sealant between the mating surfaces. The silk thread typically recommended for use as the seal is a “00” commercial grade D silk thread. A very thin coat of sealant, such as POB No. 4 Perfect Seal sealing compound from P.O.B. Inc. of Cincinnati, Ohio, is applied to the mating surface of only one of the crankcase halves. Although the primary purpose of the sealant is to hold the silk thread (which provides the actual seal) in place during assembly of the crankcase, proper application of the sealant is critical to the effectiveness of the seal. If the sealant is applied too thick, then the compression of the sealant during crankcase assembly will force some of the sealant inside the bolt holes and/or the crankcase cavity. Sealant inside the crankcase will eventually break loose and be carried by the oil until it becomes lodged in any one of the many small orifices through which the engine oil flows, which can cause loss of oil circulation through the engine and result in premature engine failure. If the amount or application of the sealant is not sufficient to hold the silk thread in place during crankcase assembly, then the silk thread can move and result in an oil leak at the crankcase mating surface interface.

Different silk thread layout patterns are utilized for different series of engines by the various engine manufactures. Generally, all of the manufactures utilize silk layout patterns that place the silk thread on the inside of the bolt holes through which the bolts pass that are utilized to hold the two crankcase halves together. Some of the silk layout patterns have the silk thread pass substantially straight by the bolt holes between the bolt holes and the wall of the crankcase cavity and others have the silk thread partially loop around the bolt holes (but only on the inside of the bolt holes). During assembly, a thin film of sealant is placed on the mating surface of only one of the crankcase halves. The sealant is placed in a manner that ensures no sealant contacts any of the bolt holes or is inside the crankcase. The silk thread is then placed on top of the sealant, along its specific layout pattern, and pressed firmly into the sealant to keep the thread in place during the crankcase assembly. The two crankcase halves are then joined together, with the silk thread and sealant disposed between, to define the assembled crankcase.

Although silk thread has been used for decades as the acceptable sealing material for air-cooled engines, in general it is not the most reliable material for performance and longevity, particularly in light of long term exposure to engine oil. Problems that are known to exist with regard to the silk thread and sealant method of sealing these engines is the use of an improper amount of sealant on the mating surface, as described above, and/or the improper placement of the silk thread and/or sealant along the mating surface. The occurrence of either of these conditions is likely to result in an oil leak and/or engine damage. In addition, for many older aircraft engines the two crankcase halves are held together with through-bolts that are known to wear and allow movement of the crankcase. This movement of the crankcase causes damage to the crankcase mating surfaces, referred to as “fretting”, which breaks down the silk thread seal and results in oil leaks at the mating surface interface.

Although the use of silk thread and sealant is currently the preferred manner in which to seal the crankcase interface for air-cooled engines, at least one manufacturer allows the use of only a sealant for field repairs due to the difficulty in applying the silk thread to the mating surfaces in the field. For instance, Lycoming allows the use of specific sealants, without the use of silk thread, for sealing the mating surfaces of the two crankcase halves. The specific sealants are RTV™-102 from the General Electric Company or Loctite®-515 from Henkel Corporation. As with the silk thread sealing method, a thin film of the sealant is applied to only one of the crankcase halves. The person placing the sealant on the mating surface must ensure that none of the sealant is in contact with any of the bolt holes or inside the crankcase cavity. The two crankcase halves are then joined together, without the use of silk thread, to define the crankcase.

Although the use of silk thread and sealant has provided a generally suitable seal for use with horizontally opposed air-cooled aircraft engines and other air-cooled engines, what is needed is an improved crankcase seal for these engines. The desired sealing mechanism should provide improved sealing performance and longevity under the conditions commonly found in air-cooled engines, such as aircraft engines, that are not adaptable to gasket seals and the like. The preferred crankcase seal should be adaptable for use to effectively seal the interface between the mating surfaces of two crankcase halves. Preferably, the improved crankcase seal is particularly effective for use on one half of a pair of matching crankcase components to seal the joined interface in a manner that reduces the likelihood of oil leaks and related engine damage.

### SUMMARY OF THE INVENTION

The improved crankcase seal for air-cooled engines of the present invention solves the problems and provides the benefits identified above. That is to say, the present invention discloses an improved crankcase seal that provides an effect seal for the interface between adjoining crankcase components. The improved crankcase seal of the present invention is particularly adaptable for use with horizontally opposed aircraft engines and other air-cooled engines having a pair of crankcase components that are joined together at their respective mating surfaces to seal the interface between these two components. The present crankcase seal provides improved sealing performance and longevity under the conditions commonly found in air-cooled engines, such as aircraft and automobile engines, that are not adaptable to gasket seals and the like. Specifically, the improved crankcase seal of the present invention is particularly effective for use to seal the joined interface of a pair of matching crankcase components in a manner that reduces the likelihood of oil leaks at the interface and the related engine damage that can occur as a result of oil loss. As set forth below, the improved crankcase seal of the present invention eliminates the problems with regard to utilizing an improper amount of sealant and with regard to the improper placement of the silk thread and/or sealant on the mating surface by eliminating these materials and any variance in placement of the sealing element used to provide the seal at the mating surface interface.

In the primary embodiment of the present invention, the improved crankcase seal for air-cooled engines is configured to efficiently and effectively seal the interface between opposing crankcase components so as to reduce the likelihood of oil leaks at that interface. In the preferred embodiment, the improved crankcase seal comprises a groove cut into the mating surface of one of the crankcase components and a generally compressible sealing member, such as an O-ring or the like, disposed in the groove. Preferably, the groove is machine cut into the otherwise generally planar mating surface with a CNC machine or like apparatus along the same path or layout that is presently utilized with the silk thread sealing method. Various shapes and sizes of the groove and sealing member are available for the crankcase seal of the present invention. In the preferred embodiment, the sealing member and groove are cooperatively sized and configured such that the sealing member is securely held in the groove during assembly of the engine crankcase. In one preferred configuration, the width of the pair of opposing upper edges of the groove is less than the width (e.g., diameter) of the sealing member such that the sealing member is lockingly engaged in the groove. In one configuration, the groove has a dovetail shaped profile and the sealing member has a generally circular cross-section. The crankcase seal of the present invention is particularly beneficial for horizontally opposed aircraft engines. In such applications, the sealing member should be made out of a material that meets or exceeds AMS 3216G physical and chemical requirements. The person assembling the crankcase obtains a crankcase component half having the groove cut into the mating surface and then presses a lubricated sealing member into the groove along the sealing path. Preferably, a slight amount of pressure, such as thumb pressure, is required to snap the sealing member into the groove to hold it there while the crankcase is assembled. The crankcase seal of the present invention eliminates the need for the sealant and the silk thread, thereby eliminating the problems associated with the quantity and placement of the sealant and placement of the silk thread.

Accordingly, the primary objective of the present invention is to provide an improved crankcase seal for air-cooled engines that provides the advantages discussed above and overcomes the disadvantages and limitations associated with presently available sealing device and systems for such engines.

It is also an important object of the present invention to provide an improved crankcase seal that effectively and efficiently seals the adjoining mating surfaces of two crankcase components so as to reduce the likelihood of oil leakage at the interface of these components.

It is also an important object of the present invention to provide an improved crankcase seal that effectively seals the opposing mating surfaces of adjoining crankcase components without the use of sealant so as to eliminate the problems associated with the use of such sealants, including an improper amount of sealant and/or improper placement of the sealant.

It is also an important object of the present invention to provide an improved crankcase seal that effectively seals the opposing mating surfaces of adjoining crankcase components that substantially reduces the likelihood that the sealing element will be improperly placed along the mating surface of one of the crankcase components so as to eliminate the problems associated with the improper placement of the prior art sealing element, such as silk thread.

It is also an important object of the present invention to provide an improved crankcase seal for air-cooled engines, including aircraft and automotive engines, that provides improved sealing performance and longevity.

In one primary aspect of the present invention the improved crankcase seal for air-cooled engines comprises a groove precisely cut into the mating surface of one of the crankcase components and a compressible seal that is inserted into the groove so as to engage the groove and be held in place thereby during assembly of the crankcase.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a pair of crankcase components that join together to form the crankcase for an air-cooled engine having a crankcase seal configured according to a preferred embodiment of the present invention shown in use on an exemplary TCM Continental engine;

FIG. 2 is a top plan view of the first crankcase component of FIG. 1;

FIG. 3 is a top plan view of a first crankcase component having the crankcase seal configured for use with an exemplary Lycoming engine; and

FIG. 4 is a partial cross-sectional view of crankcase taken through line 4-4 shown on FIG. 2 showing the sealing member lockingly engaged in the groove of the crankcase seal of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of one or more of the preferred embodiments and, as such, represent one or more ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily directed to a crankcase seal for use with air-cooled aircraft engines, those skilled in the art will readily understand that this is shown merely for purposes of simplifying the present disclosure and that the present invention is not so limited. For instance, the improved crankcase seal of the present invention can be utilized with automotive air-cooled engines and a variety of other air-cooled engines, including those which are not utilized with or in a vehicle.

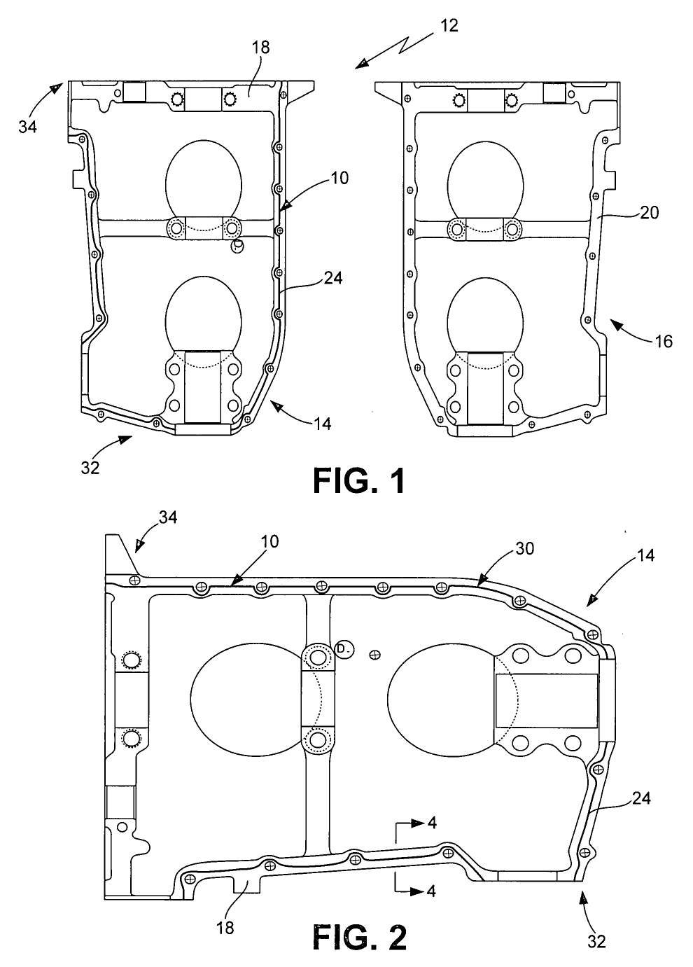

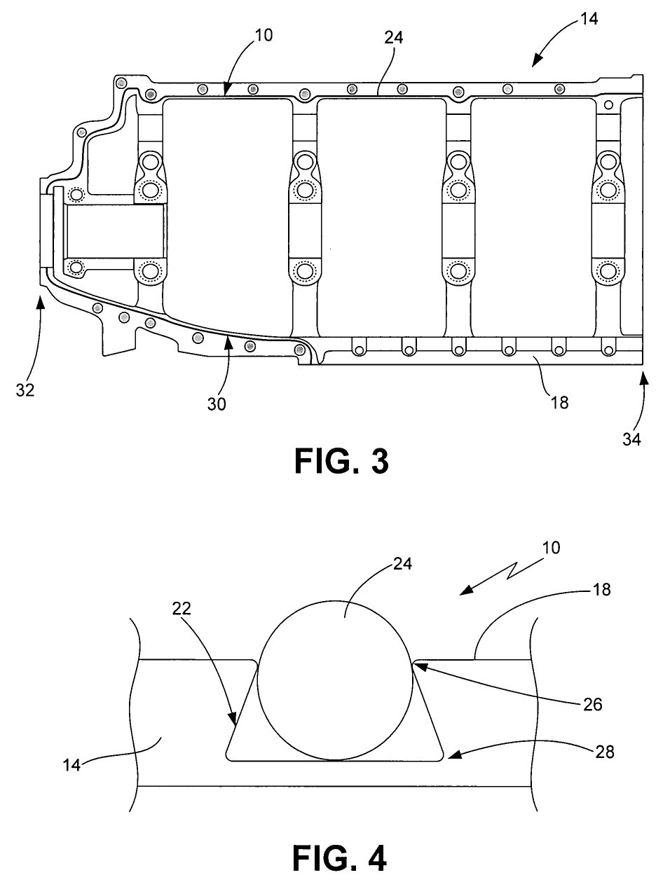

A crankcase seal for air-cooled engines that is manufactured out of the components and configured pursuant to a preferred embodiment of the present invention is shown generally as 10 in the figures. The crankcase seal 10 of the present invention is preferably and beneficially utilized with an air-cooled engine 12 having two opposing crankcase components 14 and 16 each having a mating surface 18 and 20, respectively, as shown in FIG. 1. As with the current silk thread and sealant method, crankcase seal 10 is only applied to the mating surface 18/20 of one of the crankcase components 14/16 (mating surface 18 in FIG. 1). As a result, for purposes of description and ease of illustration, FIGS. 2 and 3 show only one crankcase component, first crankcase component 14, as having the crankcase seal 10. As well known by those skilled in the art, many air-cooled engines 12 have a pair of matching or substantially matching crankcase components 14/16 that each have an opposing mating surface 18/20 that are joined together to define the engine crankcase. Although only one crankcase component 14 is shown in FIGS. 2 and 3, those skilled in the art will readily understand that there is a second cooperatively configured crankcase component 16, except for crankcase seal 10, that is joined together with the first crankcase component 12 such that the second mating surface 20 of the second crankcase component 16 is placed in abutting relation with first mating surface 18. As stated above, this type of air-cooled engine 12 (whether airplane, automobile or other) relies on the first mating surface 18 being in direct contact with the second mating surface 20, instead of relying on a gasket-type seal, to achieve the necessary seal for the engine 12 to efficiently and safely perform.

The improved crankcase seal 10 is configured to be superior in application, performance and longevity as compared to presently available sealing systems for air-cooled engines, including those which utilize the common silk thread and sealant components. The crankcase seal 10 of the present invention comprises a groove 22 placed in mating surface 18/20 of one of the crankcase components 14/16. For purposes of the present description, reference will be to groove 22 being placed in first mating surface 18 of first crankcase component 12 such that the second mating surface 20 of second crankcase component 14 will remain substantially planar so that the two mating surfaces 18/20 can be placed in abutting relation with crankcase seal 10 disposed therebetween. Those skilled in the art will readily appreciate that groove 22 can, alternatively, be beneficially placed instead in second mating surface 20 with first mating surface 18 remaining substantially planar. As explained in more detail below, groove 22 is cooperatively sized and configured to receive sealing member 24 therein to effectuate the desired seal between the first 14 and second 16 crankcase components.

Groove 22 is a face seal groove that is placed in the first mating surface 18 and cooperatively sized and configured with sealing member 24 such that sealing member 24 is received in groove 22, as best shown in FIG. 4. Although groove 22 may be provided by other means, preferably groove 22 is machined or machine cut into the previously planar surface of first mating surface 18 of first crankcase component 14. In a preferred embodiment, groove 22 is machined by clamping first crankcase component 14 in a holding fixture on a computer controlled CNC machine, such as a HAAS VF6 vertical machining center utilizing one or more solid carbide cutters. The CNC machine should mill groove 22 by following the same path or layout recommended for application of the silk thread type of seal, which layout is set based on the manufacturer's configuration of first crankcase component 14, such as shown in FIGS. 1 and 2. Various profiles or cross-sectional shapes of groove 22 can be utilized for crankcase seal 10 of the present invention, including curved, square, rectangle and like profiles. For many profiles of groove 22, the sealing member 24 will generally lay inside groove 22. Preferably, the groove 22 and sealing member 24 should be cooperatively sized and configured such that at least the side walls of groove 22 will engage sealing member 24 so as to securely hold the sealing member 24 in groove 22 during assembly of the crankcase for engine 12. This can be achieved by selecting the size and/or configuration of groove 22 and sealing member 24 such that the person who assembles crankcase seal 10 must use at least a small amount of force to push sealing member 24 into groove 22 and, after doing so, the sealing member 24 is self-held in groove 22.

A preferred shape for groove 22 is one that provides some type of mechanical mechanism for lockingly engaging the sealing member 24 in groove 22, such as requiring sealing member 24 to “snap” into groove 22, so that sealing member 24 is held in groove 22 during the assembly of the crankcase for engine 12. In a preferred embodiment, the upper edges 26 of groove 22, shown in FIG. 4, are configured such that the width between the pair of opposing upper edges 26, commonly referred to as the gland width, is less than the width (i.e., diameter) of sealing member 24, which in the preferred embodiment is an O-ring. In this configuration, the upper edges 26 of groove 22 will effectively “pinch” the sealing member 24 in groove 22 so as to lockingly engage the two components together. In general, only a slight amount of width difference, such as 0.001 to 0.009 inch, is necessary to achieve the desired holding effect. This can be achieved with a preferred configuration of groove 22, shown in FIG. 4, wherein groove 22 has an undercut or dovetail shaped profile, such as the Parker dovetail O-ring design by Parker Hannifin of Irvine, Calif. A particular benefit of this design is its ability to utilize a relatively small size O-ring (i.e., 0.070 inch diameter), to provide an adequate amount of material in the engine case and to lockingly engage or hold the sealing member 24, such as an O-ring having a circular cross-section, in the groove 22 during assembly of the crankcase. Although this particular profile is believed to work well with crankcase seal 10 of the present invention, generally it is relatively expensive to machine and it does have limitations with regard to the amount of void area and the effect of operating conditions on the sealing member 24 utilized therewith. As well known to those familiar with this type of design, the radius at upper edges 26 and lower edges 28 of groove 22 must be carefully selected because an insufficient radius will potentially cause damage to the sealing member 24 during installation and an excessive radius may contribute to extrusion. Recommended sizes for cross-sections, widths, depths and radiuses are available from well known sources, including the dovetail groove section of the Parker O-Ring Handbook. Other design profiles for groove 22 should also consider the size, material and holding characteristics, as well as other appropriate factors.

As stated above, the size and shape of sealing member 24, which will typically be an O-ring, should be selected to be cooperate with groove 22. The sealing member can have a circular, square, rectangular or various other cross-sectional profiles, as may be appropriate to be received in groove 22. The material for the sealing member 24 should be selected based on various criteria important for the intended use of crankcase seal 10, such as an air-cooled aircraft engine or an automobile engine, and should include factors such as operating temperature, resistance to petroleum products (such as engine oils, fuels and solvents), compression set and wearing ability. One important consideration for sealing member 24 is that it should not prevent the critical contact between the first 18 and second 20 mating surfaces when first 14 and second 16 crankcase components are joined to form the crankcase for engine 12. In general, the cross-section of the sealing member 24 should be such that it will deform into the groove 22 in which it is installed when compressed by the mating of first 14 and second 16 crankcase components so as to provide a reliable, long term seal to prevent oil leakage.

In one configuration, suitable for use with air-cooled aircraft engines, sealing member 24 has a generally circular cross-section and is manufactured from an O-ring material such as EE96175T, which is a black fluoroelastomer based on 100% virgin Viton® “A” type polymer with a dihydroxy/bisphenol cure system, or an equivalent or better material. This material meets or exceeds all AMS 3216G physical and chemical requirements for aerospace material specifications, as should any sealing member 24 material for aircraft application. Depending on the use of the air-cooled engine 12, such as automotive or the like, various somewhat less demanding materials may be suitable for use for sealing member 24.

Although installation of crankcase seal 10 of the present invention in first crankcase component 14 is somewhat easier, accurately repeatable and more reliable than the silk thread and sealant method presently utilized, it must nevertheless be carefully performed in order to ensure successful results. Initially, groove 22 is cut into the generally planar mating surface 18 of the first crankcase component 14, preferably by machining, along a sealing path 30 that follows the recommended layout for the silk thread utilized in the current sealing method. In FIGS. 1 through 3, sealing path 30 is shown with the sealing member 24 placed therein. As best shown in FIGS. 2 and 3, the sealing path 30 may comprise one or more sections. For instance, the sealing path 30 of the first crankcase component 14 shown in FIG. 2 has three sections, one across the top (as shown on the page), one generally across the bottom and one generally at the front end 32, whereas the sealing path 30 of the first crankcase component 14 shown in FIG. 3 has two sections, one across the top and one extending along the bottom from the front end 32 to near the middle of component 14. Prior to installation of sealing member 24 in groove 22, the installer lubricates the sealing member 24 (O-ring) with motor oil. Starting at one end of a section of sealing path 30, approximately 0.010 to 0.040 inch of sealing member 24 is left extending outwardly from the outside of first crankcase component 14. Working along the sealing path 30, the installer presses sealing member 24 into groove 22 using moderate pressure (such as thumb pressure). At the opposite end of the section of sealing path 30, the installer leaves approximately 0.125 to 0.250 inch of the sealing member 24 extending outwardly from the outside of first crankcase component 14. This process is repeated for each section. The crankcase is then assembled by joining the first 14 and second 16 crankcase components as recommended by the manufacturer's overhaul manual. After the crankcase has been torqued to the manufacturer's specification, the installer trims sealing member 24 flush with the front 32 and back 34 end surfaces.

As set forth above, the improved crankcase seal 10 of the present invention eliminates the need for the sealant and the silk thread that are currently utilized. As such, the present invention eliminates the concerns with regard to having too thin or too thick of sealant material on the first mating surface 18, which can result, respectively, in movement of the silk thread during assembly of the crankcase or the movement of excess sealant into the bolt holes or the crankcase cavity. The present invention also eliminates concerns with regard to the proper placement of the silk thread. With groove 22 cut in place and the sealing member 24 sized and configured to be lockingly engaged in groove 22, the installer does not have to worry that he or she is placing the silk thread in the wrong place or that it will move to the wrong place during assembly of the crankcase. If a field repair is necessary, the person performing the repair only has to remove the existing sealing member 24 and replace it with a new sealing member 24 of the same configuration. This relatively easy placement of the sealing member 24 and not having to worry about the quantity and placement of the sealant, will reduce the time and cost for overhauling the engine 12. The improved materials and the placement of the sealing member 24 in groove 22 will improve the operational performance of the crankcase seal 10, resulting in the engine 12 being less likely to experience an oil leak from the crankcase or other engine problems associated with leaking oil from the crankcase.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A crankcase seal for an air-cooled engine having a crankcase component with a mating surface, said crankcase seal comprising:
a groove in said mating surface of said crankcase component; and
a generally compressible sealing member disposed in said groove.

2. The crankcase seal according to claim 1, wherein said groove is cut into said mating surface.

3. The crankcase seal according to claim 2, wherein said groove is machine cut into said mating surface utilizing a CNC machine.

4. The crankcase seal according to claim 1, wherein said sealing member and said groove are cooperatively sized and configured such that said sealing member is secured in said groove.

5. The crankcase seal according to claim 4, wherein said groove lockingly engages said sealing member.

6. The crankcase seal according to claim 5, wherein the width between a pair of opposing upper edges of said groove is less than the width of said sealing member.

7. The crankcase seal according to claim 6, wherein said groove has a dovetail shaped profile.

8. The crankcase seal according to claim 7, wherein said sealing member has a generally circular cross-section.

9. The crankcase seal according to claim 1, wherein said engine is a horizontally opposed aircraft engine.

10. The crankcase seal according to claim 9, wherein said sealing member is made from a material that meets or exceeds AMS 3216G physical and chemical requirements.

11. A crankcase seal for an air-cooled engine having a crankcase component with a mating surface, said crankcase seal comprising:
a groove machine cut in said mating surface of said crankcase component; and
a generally compressible sealing member disposed in said groove, said sealing member and said groove cooperatively sized and configured such that said sealing member is securely held in said groove.

12. The crankcase seal according to claim 11, wherein the width between a pair of opposing upper edges of said groove is less than the width of said sealing member to lockingly engage said sealing member in said groove.

13. The crankcase seal according to claim 12, wherein said groove has a dovetail shaped profile and said sealing member has a generally circular cross-section.

14. The crankcase seal according to claim 11, wherein said engine is a horizontally opposed aircraft engine and said sealing member is made from a material that meets or exceeds AMS 3216G physical and chemical requirements.

15. A method of providing a crankcase seal for an air-cooled engine having a crankcase component with a substantially planar mating surface, said method comprising the steps of:
a) cutting a groove in said mating surface along a sealing path on said mating surface;
b) providing a sealing member sized and configured to be received in said groove; and
c) inserting said sealing member in said groove along said sealing path.

16. The method according to claim 15, wherein said groove is machine cut into said planar surface.

17. The method according to claim 15, wherein said sealing member and said groove are cooperatively sized and configured such that said sealing member is secured in said groove and said inserting step requires pushing said sealing member into said groove.

18. The method according to claim 15, wherein said groove lockingly engages said sealing member.

19. The method according to claim 18, wherein the width between a pair of opposing upper edges of said groove is less than the width of said sealing member.

20. The method according to claim 15, wherein said engine is a horizontally opposed aircraft engine and said sealing member is made from a material that meets or exceeds AMS 3216G physical and chemical requirements.
